(19) United States
(12) Patent Application Publication
(10) Pub. No.: US 2005/0132762 A1
(43) Pub. Date: Jun. 23, 2005

(54) Padlock

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/060,427

(22) Filed: Feb. 18, 2005

Related U.S. Application Data
(63) Continuation-in-part of application No. 10/671,659, filed on Sep. 29, 2003.
(63) Continuation-in-part of application No. 10/676,853, filed on Sep. 30, 2003, now Pat. No. 6,860,125.

(30) Foreign Application Priority Data
Aug. 22, 2003 (TW) 92215338
Aug. 15, 2003 (TW) 92214875

(51) Int. Cl. E05B 37/06

(52) U.S. Cl. 70/25

(57) ABSTRACT

A padlock mainly comprises a lock body, a restriction device, a shackle and a locking means. The lock body has a side formed with a first hole and a recess portion, which has a surface formed with a second hole and a wall. The restriction device has a restriction button formed with a notch and a driving element extended from a bottom of the restriction button. The driving element is movably mounted in the second hole of the recess portion and the restriction button is disposed within the recess portion accordingly. Furthermore, the shackle has a base end and a free end. The base end is installed within the first hole of the side and the free end is engageable and disengageable with the notch of the restriction button. The locking means is installed in the lock body for determining the engagement and disengagement between the free end of the shackle and the notch of the restriction button.

This is a continuation-in-part application of the co-pending U.S. Ser. No. 10/671,659, application filed on Sep. 29, 2003, and also a continuation-in-part application of the co-pending U.S. Ser. No. 10/676,853, application filed on Sep. 30, 2003.

### TECHNICAL FIELD

This invention relates generally to a padlock, in particular, to provide a padlock having a restriction button formed with a notch for being engageable with a free end of a shackle.

### BACKGROUND OF THE INVENTION

A conventional padlock contains a lock body, a shackle and a locking means, which is a key operated locking means or a combination locking means. The shackle has a based end installed in one side of the lock body and a free end. The lock body has a concave at the other side thereof and the concave is provided for the engagement or the disengagement with the fee end of the shackle. The locking means is provided for determining vertical movement of the base end so as to determine the movements of the free end of the shackle. When the locking means is unlocked, the free end of the shackle is disengaged with the concave of the lock body.

Another conventional padlock contains a lock body, a shackle, a button member and a locking means, which comprises a key operated locking means and/or a combination locking means. The shackle has a base end installed in one side of the lock body and a free end. The button member is mounted to the lock body and has a button exposed and projected from a side of the lock body. The button of the button member is provided for the engagement or the disengagement with the free end of the shackle. The locking means is provided for determining movements of the base end and/or the button member so as to determine the movements of the free end of the shackle. When the locking means is unlocked, the free end of the shackle is disengaged with the button of the button member.

However, conventional padlocks with exposed and projected buttons are easily to be damaged by tools. Therefore, padlocks with secure button members and with favorable operating functions are in a great demand.

### SUMMARY OF INVENTION

It is therefore an objective of the present invention to provide a padlock, which has an improved structure and characteristics of favorable operating functions.

The present invention, briefly summarized, in one embodiment discloses a padlock, which comprises a lock body, a restriction device, a shackle and a locking means. More particularly, the lock body has a side formed with a first hole and a recess portion, which has a surface formed with a second hole and a wall connected with the side and the surface. In addition, the surface of the recess portion is parallel to the side of the lock body. The restriction device has a restriction button formed with notch on a top of the restriction button and a driving element extended from a bottom of the restriction button. The driving element is mounted in and is movable within the second hole of the surface. In addition, the shackle has a base end and a free end. The base end of the shackle is movably installed within the first hole of the side and the free end of the shackle is engageable and disengageable with the notch of the restriction button. Furthermore, the locking means is installed in the lock body for determining the engagement and disengagement between the free end of the shackle and the notch of the restriction button.

### BRIEF DESCRIPTION OF DRAWINGS

The invention will be more clearly understood after referring to the following detailed description read in conjunction with the drawings wherein:

FIG. 1 is a perspective view of a first embodiment of present invention, showing a lock body;

FIG. 2 is a perspective assembled view of the first embodiment;

FIG. 3 a perspective exploded view of a first embodiment;

FIG. 4 is a cross sectional view of the locked first embodiment;

FIG. 4-A is a top view according to FIG. 4;

FIG. 5 is a cross sectional view of the unlocked first embodiment;

FIG. 5-A is a top view according to FIG. 4;

FIG. 6 a perspective assembled view of the first embodiment;

FIG. 7 is a cross sectional view of the second embodiment;

FIG. 8 is a cross sectional view of the unlocked second embodiment;

FIG. 9 is a perspective view of the second embodiment showing the free end of the shackle being released from the notch of the restriction button;

FIG. 10 is a perspective view of a second embodiment, showing a key operated locking means;

FIG. 11 is a cross sectional view of the second embodiment showing the shackle being unlocked by a combination locking means;

FIG. 12 is a perspective view of the third embodiment;

FIG. 13 is a perspective view of the third embodiment showing the shackle being unlocked by a combination locking means;

FIG. 14 is a perspective view showing a restriction button being a cylinder shape;

FIG. 15 is a perspective view showing the cylinder shape restriction button being in a unlock position;

FIG. 16 is a perspective view showing a restriction button being a block shape;

FIG. 17 is a perspective view showing the block shape restriction button being in a unlock position.

### DETAILED DESCRIPTION OF PREFERRED EMBODIMENTS

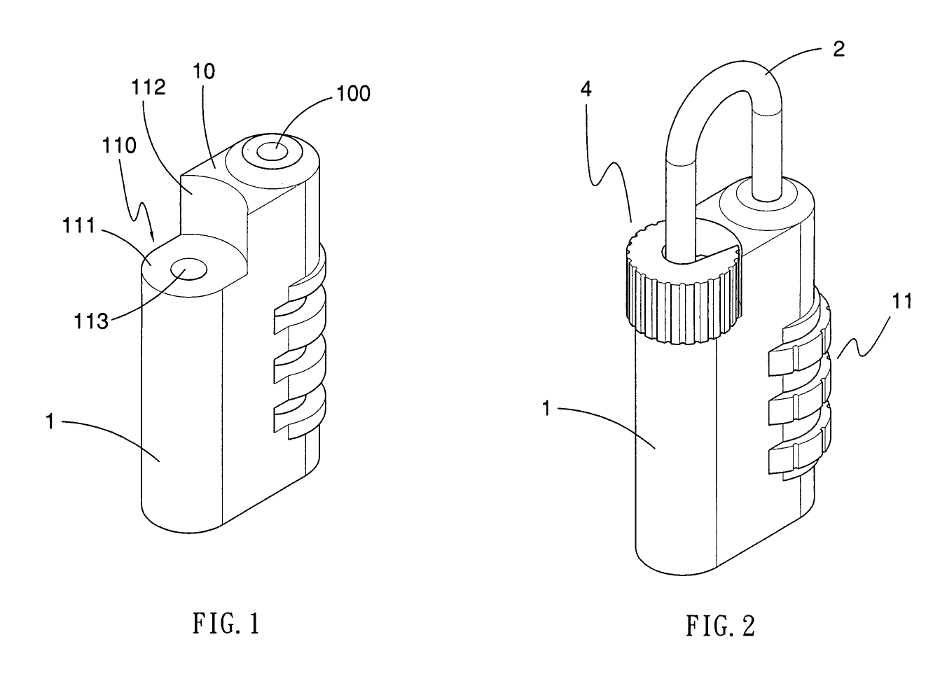

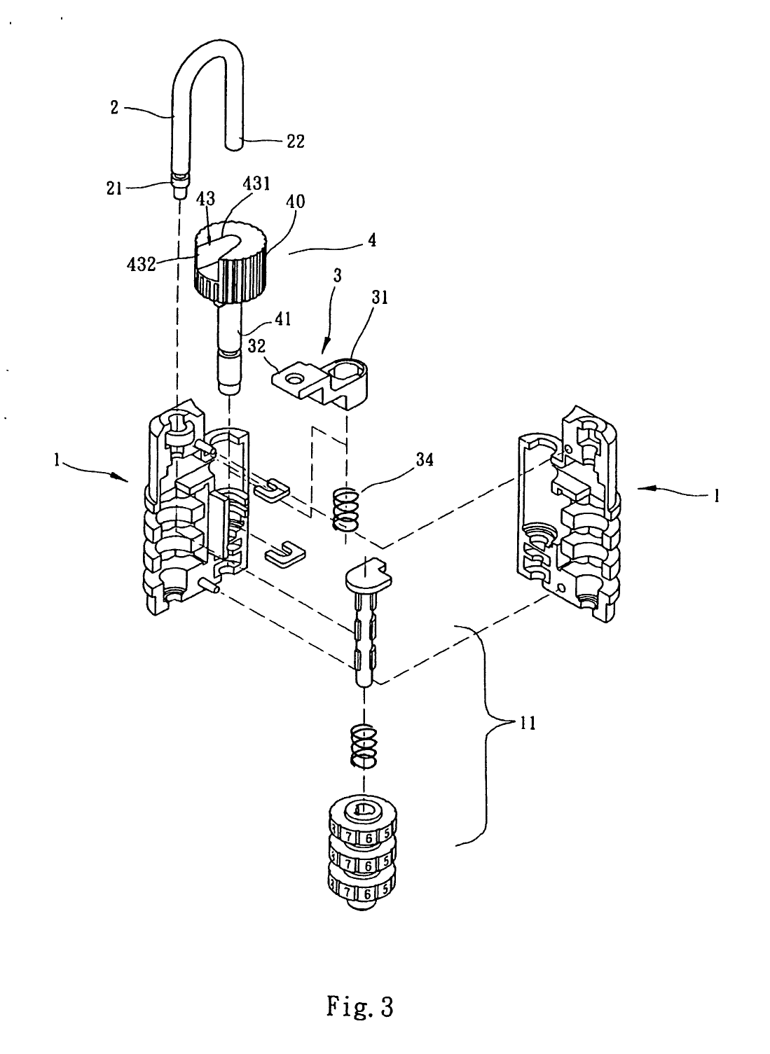

FIGS. 1-5 show a first embodiment of the present invention. The padlock of the first embodiment includes a lock body 1, a shackle 2, a restriction device 4 and a locking means. In FIG. 1, the lock body 1 has a side 10 formed with a first hole 100 and a recess portion 110. The recess portion 110 has a surface 111 formed with a second hole 113 and a wall 112 connected with the side 10 and the surface 111. In addition, the surface 111 of the recess portion 110 is parallel to the side 10 of the lock body 1. The restriction device 4 has a restriction button 40 formed with a notch 43 on a top of the restriction button 40 and a driving element 41 extended from a bottom of the restriction button 40. The driving element 41 is mounted in and is movable within the second hole 113 of the surface 111. Therefore, the restriction button 40 is disposed within the recess portion 110 accordingly.

In addition, the notch 43 of the restriction button 40 could be varied shape according to its applications, such as a shape of gap, hole and groove etc. In the first embodiment, the notch 43 of the restriction button 40 is preferable to be shaped into a gap for communicating with the center 431 and the periphery 432 of the restriction button 40. In addition, the wall 112 of the recess portion 110 is a curve wall and the periphery 432 of the restriction button 40 is shaped to match the wall 112 of the recess portion 110.

The shackle 2 has a base end 21 and a free end 22. The base end 21 of the shackle 2 is movably installed within the first hole 100 of the side 10 and the free end 22 of the shackle 2 is engageable and disengageable with the notch 43 of the restriction button 40. The shackle 2 of the present invention is preferably a U-shaped shackle. Furthermore, the locking means is installed in the lock body 1 for determining the engagement and disengagement between the free end 22 of the shackle 2 and the notch 43 of the restriction button 40. In addition, the locking means of the first embodiment further comprises a combination locking means 11, a linking member 3 and a resilient member 34. The linking member 3 has a first portion 32 connected with the combination locking means 11 and a second portion 31 connected with the driving element 41 of the restriction device 4, so as to allow the restriction device 4 being movable when the combination locking means 11 is unlocked. The resilient member 34, such as a spring, is connected with the linking member 3 for restoring the linking member 3 to its original position, as shown in FIGS. 2 to 5. For the first embodiment, the locking means could be either the combination locking means 11 or a key operated locking means.

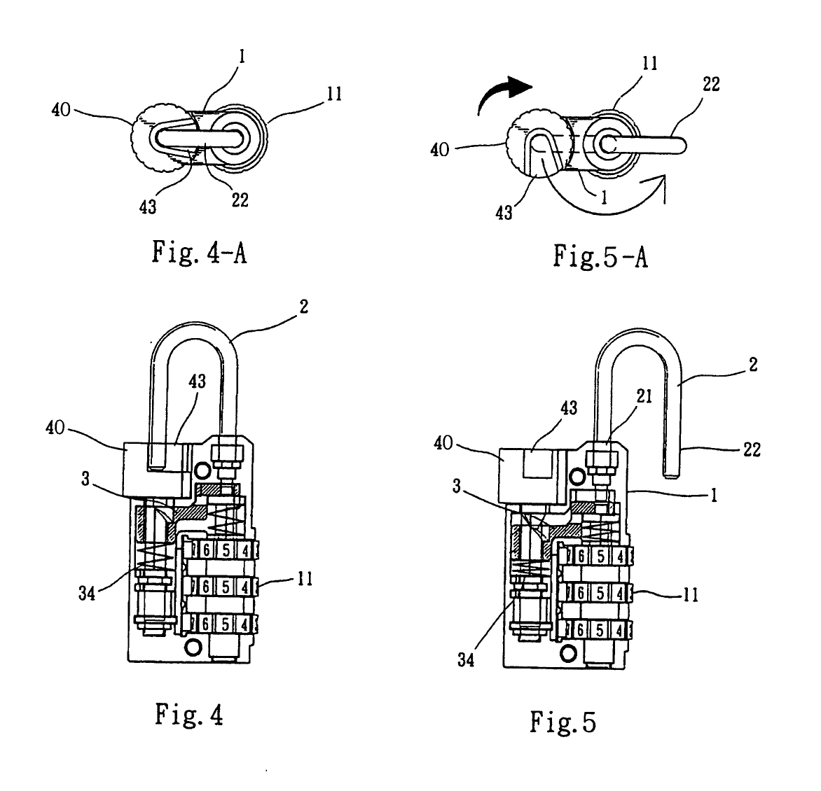

In FIGS. 4 and 4-A, the padlock of the first embodiment is in a locked status that the free end 22 of the shackle 2 is engaged with the notch 43 of the restriction button 40. Because to the combination locking means 11 of the locking means is locked, the movement of the linking member 3 is therefore limited, so as to restrict the movement of the restriction device 4 accordingly. FIGS. 5 and 5-A show that the padlock of the first embodiment is in an unlocked status that the free end 22 of the shackle 2 is disengaged with the notch 43 of the restriction button 40. More specifically, when the combination locking means 11 of the locking means is unlocked, the limited linking member 3 is accordingly released. Therefore, the restriction device 4 is allowed to move and the restriction button 40 of the restriction device 4 can be rotated to 90 degrees approximately. Meanwhile, the driving member 41 of the restriction device 4 drives the linking member 3 to press the resilient member 34 downwardly and the resilient member 34 therefore generates a force for restoring the linking member 3 to its original position while locking. As a result, the free end 22 of the shackle 2 can be rotated to an unlocking position about the base end 21 of the shackle 2 and disengaged with the notch 43 of the restriction button 40.

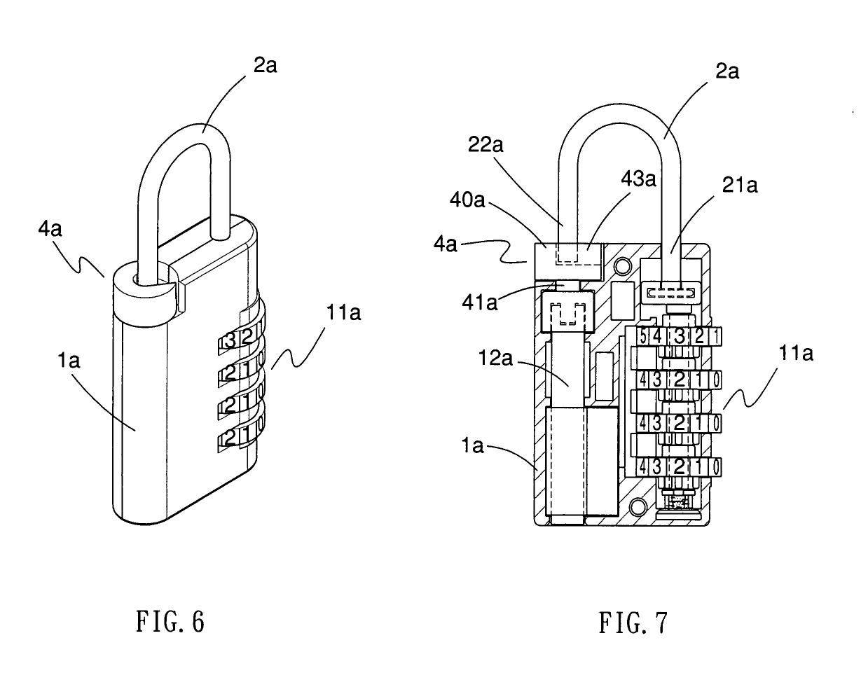

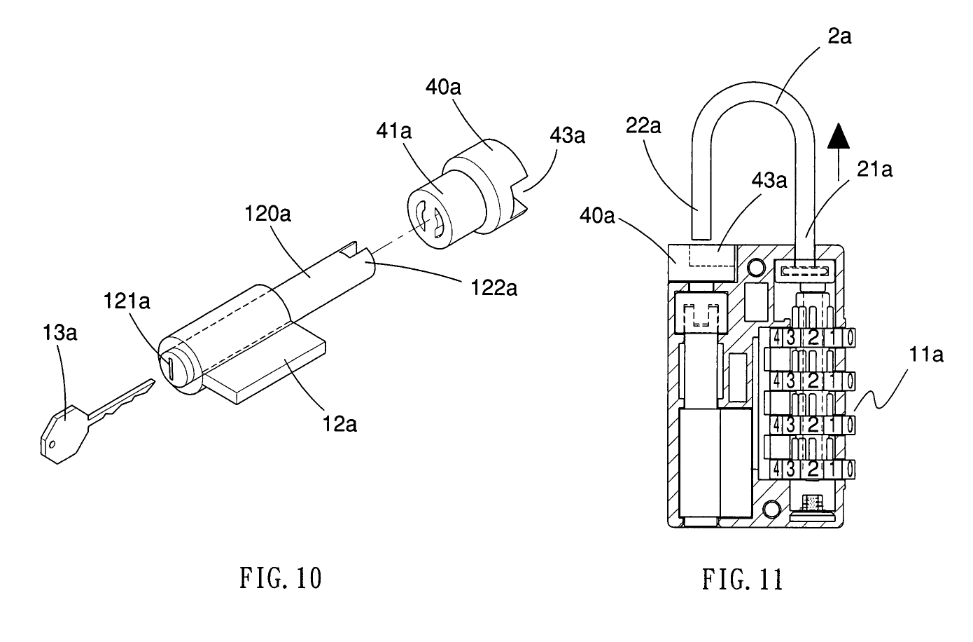

FIGS. 6-11 show a second embodiment of the present invention. The padlock of the second embodiment invention includes a lock body 1a, a shackle 2a, a restriction device 4a and a locking means. Because the elements of the lock body 1a, shackle 2a and the restriction device 4a are as same as the lock body 1, shackle 2 and the restriction device 4 of the first embodiment except the locking means; therefore, the detailed descriptions of the lock body 1a, shackle 2a and the restriction device 4a is omitted from the second embodiment.

In FIGS. 6-9, the locking means of the second embodiment comprises a combination locking means 11a and a key operated locking means 12a. The combination locking means 11a of the locking means is connected with the base end 21a of the shackle 2a, whereby the base end 21a of the shackle 2 is free to descend and ascend when the combination locking means 11a of the locking means is unlocked. In addition, the key operated locking means 12a of the locking means is connected with a driving element 41a of the restriction device 4a, whereby the restriction device 4a is rotatable when the key operated locking means 12a of the locking means is unlocked by a key 13a.

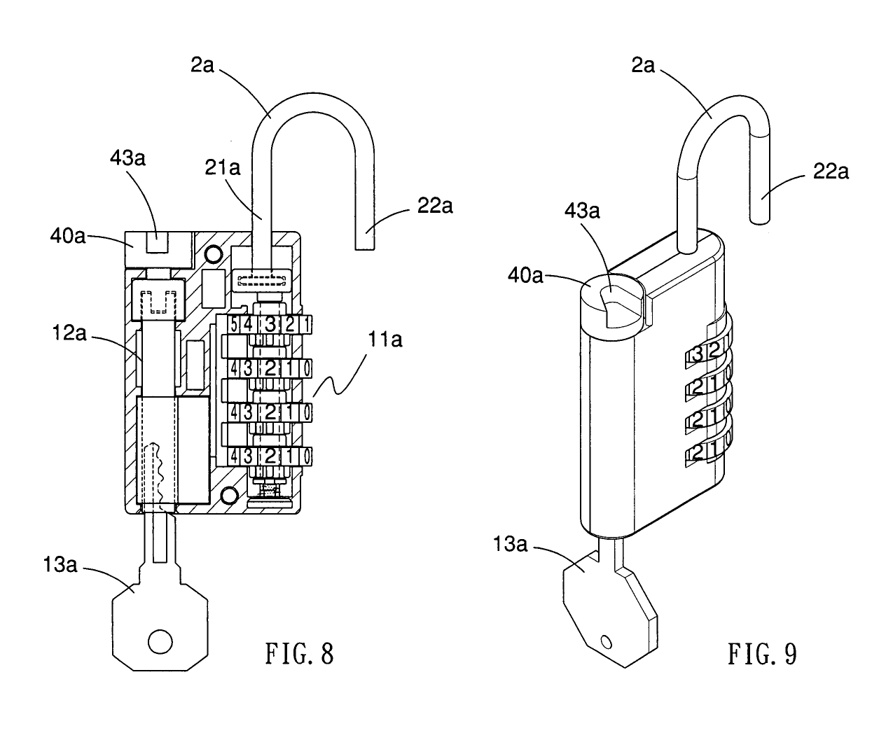

FIGS. 6 and 7 show the padlock of the second embodiment is in a locked status that a free end 22a of the shackle 2a is engaged with a notch 43a of the restriction button 40a. Because the combination locking means 11a and the key operated locking means 12a of the locking means are locked, the movements of the restriction device 4a and the shackle 2a are restricted accordingly. FIGS. 8 to 10 show the padlock of the second embodiment is in an unlocked status that the free end 22a of the shackle 2a is disengaged with the notch 43a of the restriction button 40a. More specifically, the key operated locking means 12a of the locking means comprises a rotor 120a, which has a keyhole 121a at an end of the rotor 120a and a driving portion 122a at the other end of the rotor 120a. The keyhole 121a of the rotor 120a is provided for inserting the key 13a and the driving portion 122a is provided for connecting with the driving element 41a of the restriction device 4a so as to drive the restriction device 4a. Therefore, when the key operated locking means 12a of the locking means is unlocked by the key 13a, the rotor 120a of the key operated locking means 12a drives the restriction device 4a. Therefore, the restriction button 40a of the restriction device 4a can be rotated to 90 degrees approximately. As a result, the free end 22a of the shackle 2a can be rotated to an unlocking position about the base end 21a of the shackle 2a and disengaged with the notch 43a of the restriction button 40a.

FIG. 11 shows that the padlock of the second embodiment is unlocked by the combination locking means 11a. When the combination locking means 11a is unlocked, the base end 21a of the shackle 2 is free to ascend to a position and the free end 22a of the shackle 2a can be rotated to an unlocking position about the base end 21a of the shackle 2a and disengaged with the notch 43a of the restriction button 40a.

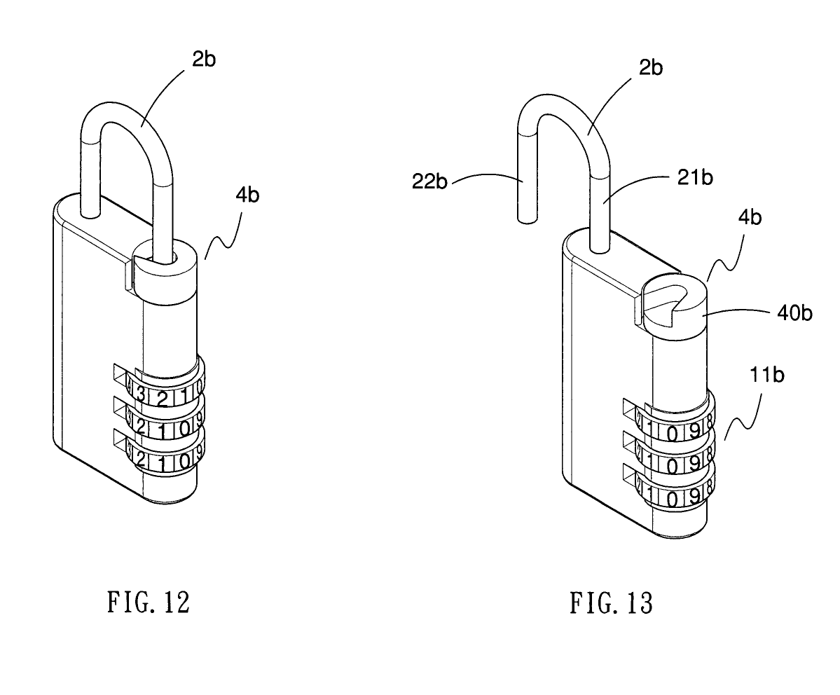

According to the second embodiment, FIGS. 12 and 13 show a third embodiment of the present invention, which has the same elements of the second embodiment, such as the lock body 1a, the shackle 2a and the restriction device 4a of the second embodiment but the positions of the combination locking means 11a and the key operated locking means 12a are shifted. More specifically, a key operated locking means (not shown) of the third embodiment is connected with a base end 21b of a shackle 2b, whereby the base end 21b of the shackle 2b is free to descend and ascend when the key operated locking means of the locking means is unlocked. In addition, a combination locking means 11b of the locking means is connected with a driving element (not shown) of a restriction device 4b, whereby the restriction device 4b is rotatable when the combination locking means 11b of the locking means is unlocked. In FIG. 13, the padlock is unlocked by the combination locking means 11b.

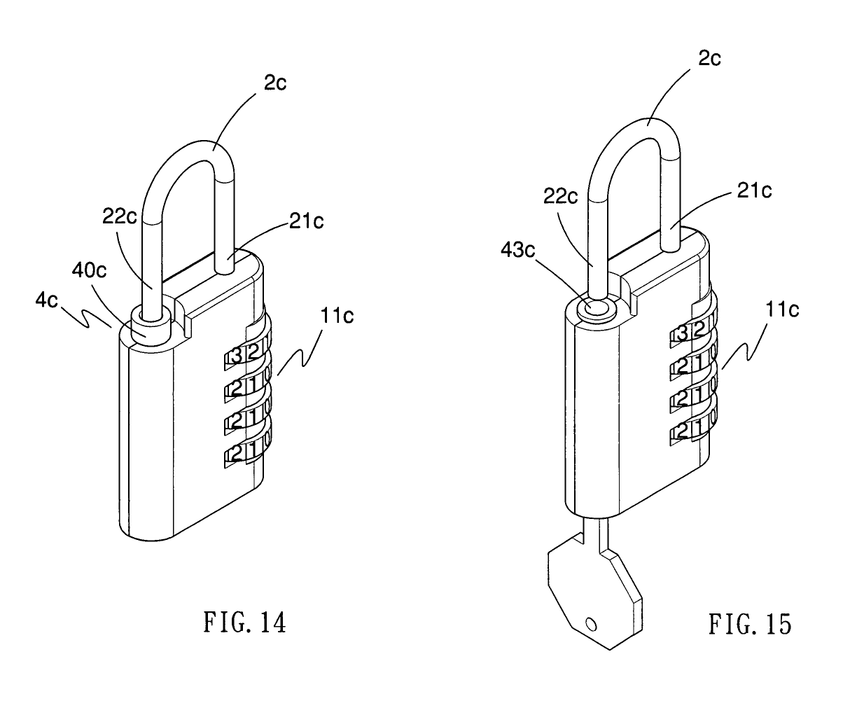

Furthermore, the restriction button of the restriction device also can be varied according the applications of the present invention. As shown in FIGS. 14 and 15, a restriction button 40c of a restriction device 4c is a cylindrical shape. A notch 43c is formed on the top-centered of the restriction button 40c. When a key operated locking means is unlock by a key 13c, the restriction button 40c of the restriction device 4c is descended to a position and a free end 22c of the shackle 2c is disengaged with the notch 43c of the restriction button 40c. On the contrary, when a combination locking means 11d is unlock, a base end 21c of the shackle 2c is ascended to a position and the free end 22c of the shackle 2c is disengaged with the notch 43c of the restriction button 40c.

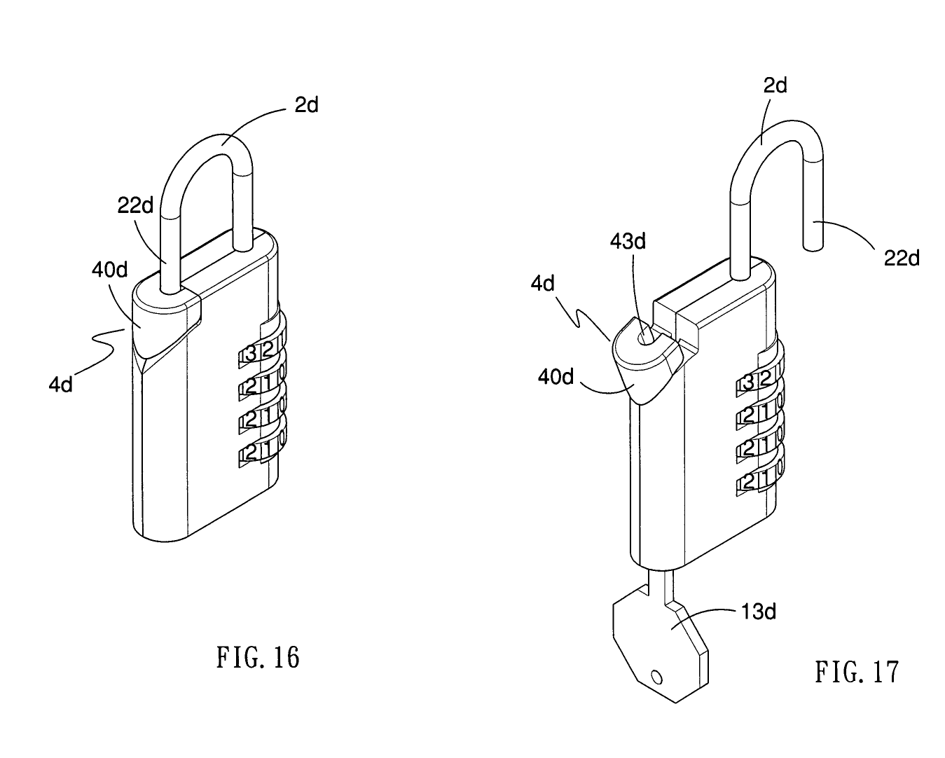

FIGS. 16 and 17 show a restriction button 40d of a restriction device 4d is a block shape. A notch 43d is formed on the top of the restriction button 40d and the notch 43d of the restriction button 40d communicates with the center and the periphery of the restriction button 40d. Similarly, when a key operated locking means is unlock by a key 13d, the restriction button 40d of the restriction device 4d is rotated to a position and the free end 22d of the shackle 2d is disengaged with the notch 43d of the restriction button 40d.

The present invention provides with a padlock, which has a restriction device disposed within a recess portion of a lock body that presents a favorable unity appearance. In addition, a padlock with multi-operating functions, such a combination locking means and/or a key operated locking means, satisfies all kinds of consumers. Furthermore, without exposing from the lock body, the restriction device of the present invention prevents the padlock from damages by using tools, so as to have a better security for the consumers.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extend indicated by the broad general meaning of the terms in which the appended claims are expressed.

1. A padlock comprising:
a lock body having a side formed with a first hole and a recess portion, the recess portion having a surface formed with a second hole and a wall connected with the side and the surface, wherein said surface is parallel to the side;
a restriction device having a restriction button formed with a notch on a top of the restriction button and a driving element extended from a bottom of the restriction button, the driving element being mounted in and being movable within the second hole of the surface, wherein the restriction button is disposed within the recess portion;
a shackle having a base end and a free end, the base end of the shackle being movably installed within the first hole of the side and the free end of the shackle being engageable and disengageable with the notch of the restriction button; and
a locking means installed in the lock body for determining the engagement and disengagement between the free end of the shackle and the notch of the restriction button.

2. The padlock of claim 1, wherein the notch of the restriction button communicates with the center and the periphery of the restriction button.

3. The padlock of claim 1, wherein the wall of the recess portion is a curve wall and the periphery of the restriction button being shaped to match the wall of the recess portion.

4. The padlock of claim 2, wherein the locking means comprises:
a combination locking means;
a linking member having a first portion and a second portion, the first portion connected with the combination locking means and the second portion connected with the driving element of the restriction device, whereby the restriction device is movable when the combination locking means is unlocked; and
a resilient member connected with the linking member for restoring the linking member to its original position.

5. The padlock of claim 2, wherein the locking means comprises:
a key operated locking means connected with the driving element of the restriction device, whereby the restriction device is rotatable when the key operated locking means is unlocked by a key.

6. The padlock of claim 2, wherein the locking means comprises:
a combination locking means connected with the base end of the shackle, whereby the base end of the shackle is free to descend and ascend when the combination locking means is unlocked; and
a key operated locking means connected with the driving element of the restriction device, whereby the restriction device is rotatable when the key operated locking means is unlocked by a key.
